(19) United States
(12) Patent Application Publication
(10) Pub. No.: US 2006/0275031 A1
(43) Pub. Date: Dec. 7, 2006

(54) Revolving lens module for mobile communication devices

(75) Inventors: Hung-Chung Ku, Taipei (TW); Chih-Kai Hu, Taipei (TW); Pin-An Hsieh, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/441,063

(22) Filed: May 26, 2006

(30) Foreign Application Priority Data
Jun. 3, 2005 (TW) 94118443

(51) Int. Cl. G03B 19/00

(52) U.S. Cl. 396/429

(57) ABSTRACT

A revolving lens module mounted to a case of a mobile communication device includes a revolving lens. The revolving lens has a rotating axis pivotally mounted to a hole of the case and an image-capturing unit for capturing images. By providing the pivotal pair of the hole and the rotating axis, the revolving lens can then have a 180 viewing range with respect to the case of the mobile communication device.

### FIELD OF THE INVENTION

The present invention relates to a mobile communication device, more particularly to a mobile communication device having a revolving lens.

### BACKGROUND OF THE INVENTION

In the recent decade, technology in the mobile communication device has been changed from a simple wireless communication tool to an entertainment combo with photographing function. In addition, the screen of the mobile communication device is also progressed from a monochrome screen to a shining color one. Actually, the cellular phone with photographs function becomes the mainstream in the market. Generally, a bar-type cellular phone with photographing function has a camera lens established in a hole on the frontage or back of the phone case. Thus, a user needs to aim the lens at the person or the scenery in which he/she is interested in photographing.

FIG. 1 shows a frontage view and a lateral view of a conventional bar-type cellular phone with photographing function. The cellular phone 1 includes a display screen 11, an operation key group 12, a lens 13 and a camera shutter button 14. The user aims the lens 13 at the goal, adjusts the focus of the camera, and then presses the camera shutter button 14 to take the picture.

FIG. 2 shows a perspective view of a conventional flip-type cellular phone with photographing function. The cellular phone 2 includes a body 21 expanding on an x-y plane as shown and a revolving lens 22 mounted inside an hole 211 at a pivotal lateral side of the body 21. The revolving lens 22 can have a swing range of 0-180° along a y-z plane corresponding to the x-y plane lying the body 21. An image-capturing unit 222 located at a pivotal center of the lens 22 is further introduced to pick up an image captured by the revolving lens 22.

However, the conventional cellular phone with photographing function has the following shortcomings:

1. Regarding the conventional cellular phone shown in FIG. 1, because the lens is fixed at the reverse side of the case, the user wanting to carry out an autodyne is unable to see his/her own image on the display screen located on the frontage of the case.

2. Regarding the conventional cellular phone shown in FIG. 2, because the lens can only move along the y-z plane perpendicular to the x-y plane that lies the display screen, a frequent change upon the case as well as the user's position is needed to take an image deviating from the y-z plane.

3. Also regarding the conventional cellular phone shown in FIG. 2, though the design having the lens swing-able between the frontage and the reverse side of the phone body solves the trouble described in foregoing shortcoming point 1, yet the inconvenience for the lens to capture a lateral image does still remain unsolved.

Therefore, the application of the current cellular phone with photographing function is still uncomfortable in arbitrary image-capturing and thus yet to be improved.

### SUMMARY OF THE INVENTION

The object of the present invention is to provide a mobile communication device having a revolving lens.

In accordance with the embodiment of the present invention, a mobile communication device includes a case and a revolving lens, in which the case has an hole and the revolving lens has a rotating shaft and an image-capturing unit. The rotating shaft is pivotally mounted in the hole and revolves along a vertical plane essentially parallel with the case. The revolving lens rotates with the rotation shaft along a horizontal plane essentially perpendicular to the vertical plane, so as to rotate the revolving lens with respect to the case of the mobile communication device.

In the embodiment of the present invention, the case includes a display screen for the user to real-time monitor the image captured by the rotating revolving lens.

In accordance with the embodiment of the present invention, the mobile communication device can be a bar type PDA.

In accordance with the embodiment of the present invention, the rotating axis can utilize a C clip to pivot about the hole.

In the embodiment of the present invention, by defining the plane for the case of the mobile communication device lay on as an x-y plane, the revolving lens pivotally mounted in the case can rotate around the y axis or the x axis. Also, the maximum rotation range of the revolving lens is a 180-degree range. The image-capturing unit can be a CCD or a CMOS.

In the embodiment of the present invention, the user can be easy to determine the photographing angle without substantially turning the case of the mobile communication device. Also, while in adjusting the photographing angle, the user can have a better monitoring state upon the display screen of the mobile communication device so that the photographing operation of mobile communication device can be easier.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a frontage and side view of a conventional mobile communication device with photographing function;

FIG. 2 is a perspective view of a conventional flip-type mobile communication device with photographing function;

FIG. 3A is a perspective view of a preferred mobile communication device having a revolving lens of the present invention;

FIG. 3B is another perspective view of the phone of FIG. 3A;

FIG. 3C is a perspective view of the phone of FIG. 3B with the revolving lens directing at a lateral direction;

FIG. 3D is a perspective view of the phone of FIG. 3B with the revolving lens directing at a front direction;

FIG. 4 is an exploded view of a preferred revolving lens of the present invention;

FIG. 5A is a schematic sectional view of the preferred revolving lens of the present invention;

FIG. 5B is another schematic sectional view of the preferred revolving lens of the present invention;

FIG. 6A is a perspective view of another mobile communication device having a revolving lens of the present invention;

FIG. 6B shows the revolving lens module of FIG. 6A turned to an upward direction;

FIG. 6C shows the revolving lens module of FIG. 6A turned to a rearward direction; and

FIG. 6D is a schematic sectional view along line C-C′ of FIG. 6C upon the revolving lens.

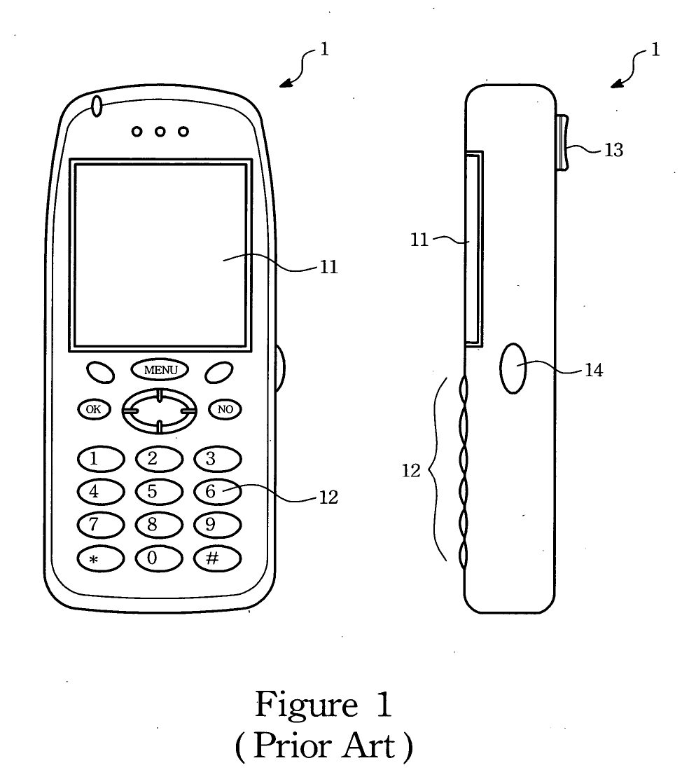

### DETAILED DESCCRIPTIONS OF THE PREFERRED EMBODIMENT

To resolve the shortcomings of the conventional mobile communication device with photographing function, the present invention disclosing a mobile communication device having a revolving lens to pick up the image is provided.

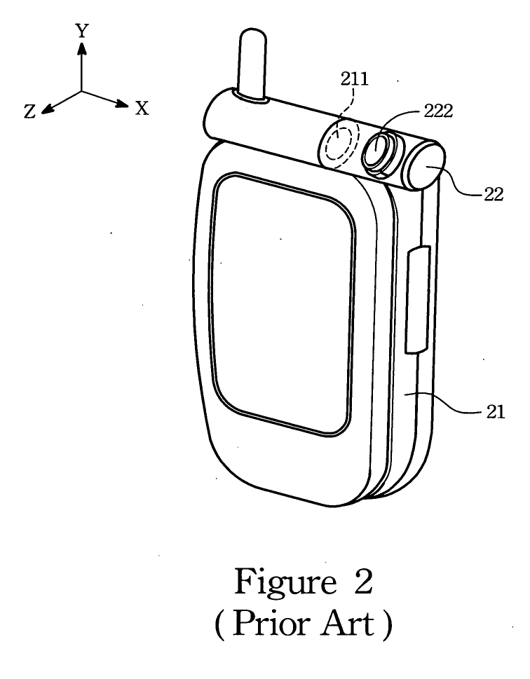

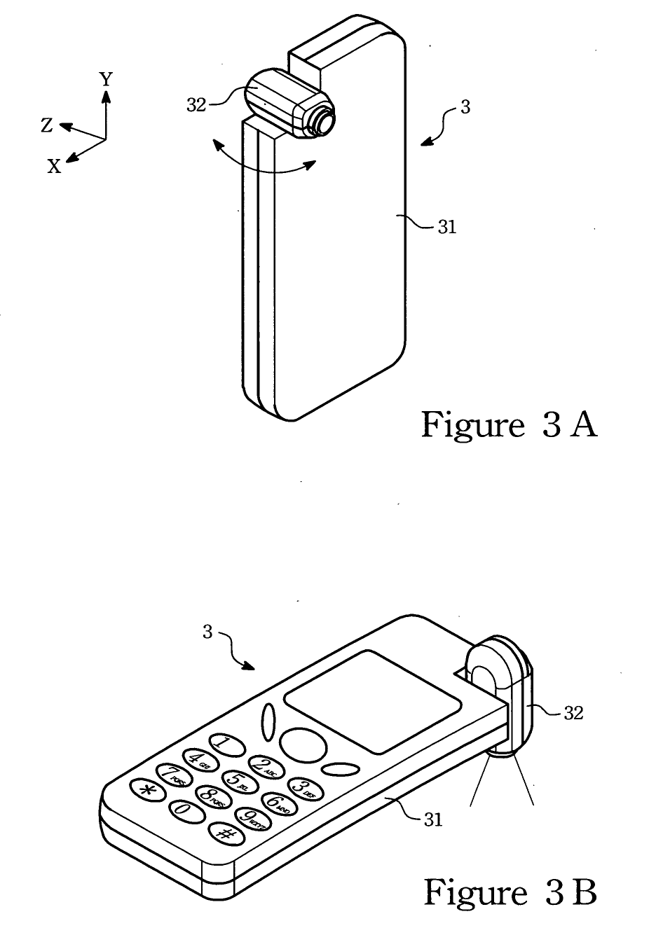

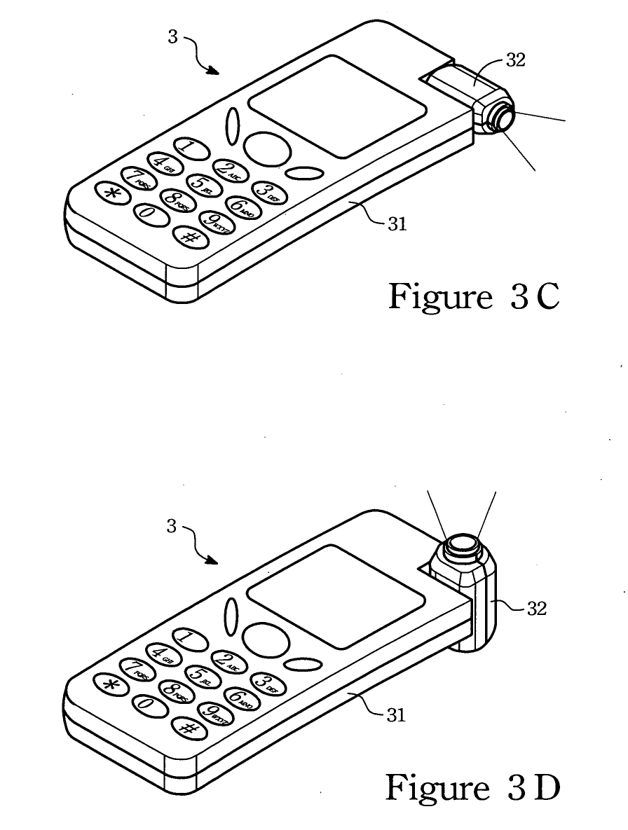

Referring to FIGS. 3A, a perspective view of the preferred mobile communication device having a revolving lens of the present invention is shown. The mobile communication device 3 includes a case 31 and a revolving lens 32, in which the revolving lens 32 is mounted to a corner aperture at a top edge of the case 31 so as to obtain a wider rotation range perpendicular to the case 31 as shown by the dual-arrow arc adjacent to the revolving lens 32. By comparing to the phone 2 shown in FIG. 2, the revolving lens 32 of the present invention is rotational along the x-z plane. In particular, the rotation degree of the revolving lens 32 can vary arbitrarily from 0° to 180°, in which a 180-degree is shown in FIG. 3A.

Further, referring to FIGS. 3B, 3C and 3D, perspective views upon the mobile communication device 3 with the revolving lens 32 posed at various rotation degrees are shown, in which FIG. 3B shows the revolving lens 32 at a 180-degree state as the same to that in FIG. 3A, FIG. 3C shows the revolving lens 32 at a 90-degree state, and FIG. 3D shows the revolving lens 32 at a 0-degree state, respectively.

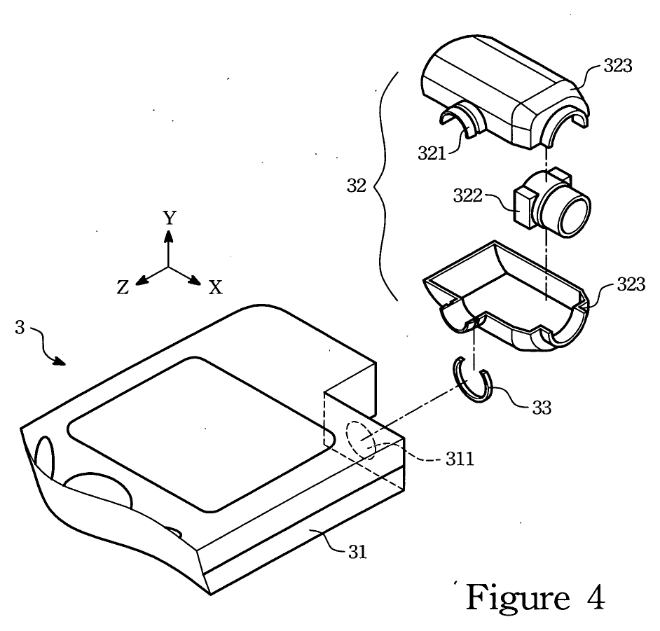

Referring to FIG. 4, an exploded view of the preferred revolving lens module of the present invention is shown. The revolving lens module rotationally mounted to the case 31 includes a C clip 33 and the revolving lens 32.

The case 31 as shown is parallel to the x-z plane and provides an accommodation aperture at a top corner edge thereof for mounting the revolving lens module. The revolving lens 32, mounted to the case 31 through a hole 311 of the case 31, has a rotation axis 321 to mate the hole 311, an image-capturing unit 322 and a lens shell 323 for accommodating the image-capturing unit 322. The rotating axis 321 pivoting through the C clip 33 as well as the hole 311 enables the revolving lens 32 to revolve along the x-y plane, i.e. about the z axis. In the present invention, the revolving lens 32 is preferably to revolve at a 0-180 degree range.

As shown, the image-capturing unit 322 is accommodated inside the lens shell 323 which is formed by two halves as illustrated in FIG. 4. After signal connections to the case 31 through the hole 311, the revolving lens 32 can fully pick up images in the revolving scope. In the present invention, the image-capturing unit 322 can include a charge-coupled device (CCD) or a complementary metal oxide semiconductor (CMOS).

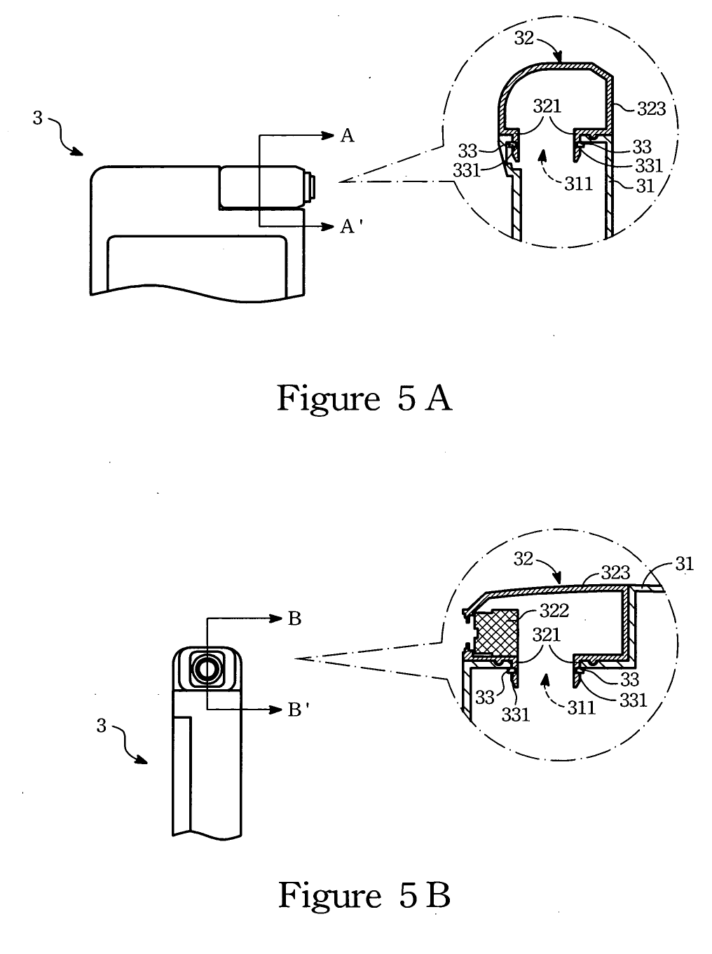

Referring to FIG. 5A and FIG. 5B, two sectional views of the revolving lens of the present invention are shown.

In AA′ line of FIG. 5A ,the rotating shaft 321 has an exterior circular notch 331 to match with the C clip 33 so as to perform pivotal movement of the revolving lens 32 about the hole 311 of the case 31. Referring to BB′ line of FIG. 5B, it is shown that the image-capturing unit 322 is set in the revolving lens 32. With the rotation shaft 321 rotating around the hole 311 of the case 31 horizontal planes, the revolving lens 32 can revolve horizontally, in view of FIG. 5B, at an arbitrary angle between 0 to 180 degrees. In the present invention, the image-capturing unit 322 can utilize a flexible printed circuit board (not shown in the figures) to provide a plurality of contact terminals to electrically connect to appropriate terminals inside the case 31 through the hole 311 and the rotation shaft 321.

Also, in the present invention, the C clip 33 of the revolving lens 32 of the mobile communication device 3 is not definitely limited to the shape or type described above. Equally, any proper locating and rotational pair, such as a wedge hook and indent pair in the art, can also be a proper alternative to meet the pivotal function originally played by the combination of the C clip 33 and the notch 331.

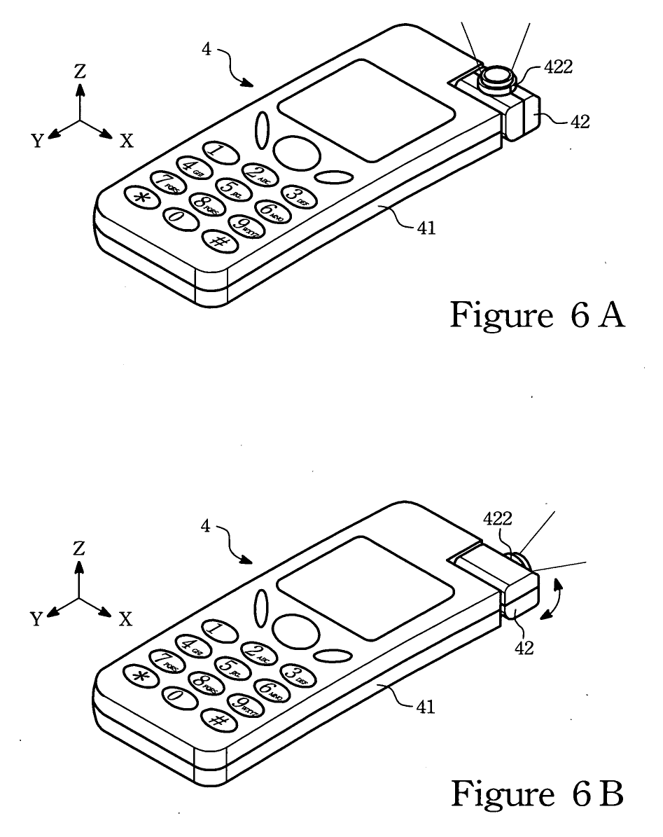

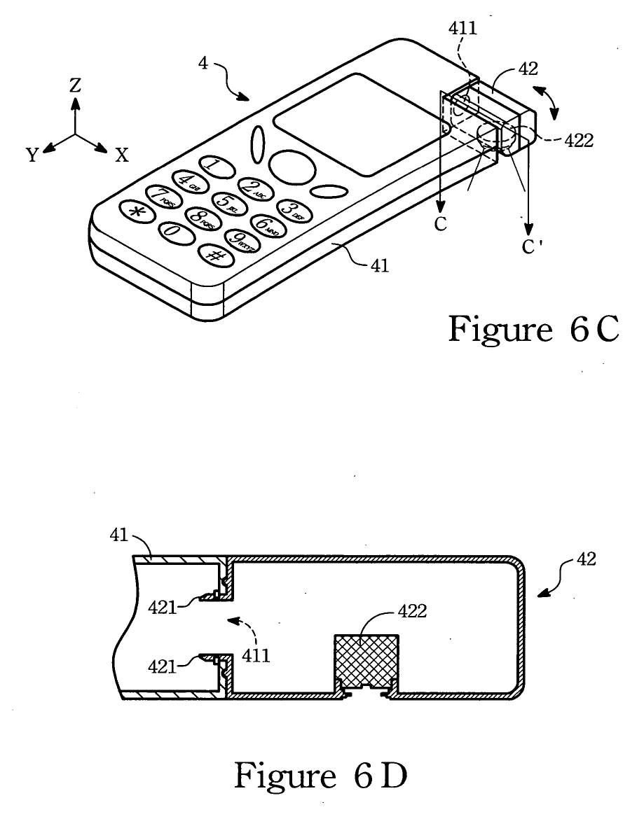

Referring to FIG. 6A through FIG. 6C, another embodiment of the mobile communication device 4 having a revolving lens 42 in accordance with the present invention is shown in three perspective views with different states of the revolving lens 42.

In FIGS. 6A-6D, a cellular phone 4 includes a case 41 and a revolving lens 42. The case 41 is lay on the x-y plane. The revolving lens 42 mounted to a top corner aperture of the case 41 can rotate on the y-z plane respective to the x-y plane of the case 41. The revolving lens 42 then can revolve from the frontage to the back of the case 41, i.e. a 180-degree range with respect to the y-axis. The pivotal engagement between the case 41 and the revolving lens 42 is again achieved by a pair of a hole 411 of the case 41 and a rotating shaft 421 of the revolving lens 42 (the pivotal mechanism is the same as that described above). However, a major difference between this embodiment and the foregoing one is that the rotation of the revolving lens 42 in this embodiment is about the x-axis, by comparing to the z axis in the previous embodiment. The image-capturing unit 422 is set in a center portion of the revolving lens 42. Also, for the electrical connections between the revolving lens 42 and parts in the case 41 is well known to the art, details regarding those connections will be omitted herein.

In FIG. 6A, FIG. 6B and FIG. 6C, the revolving lens 42 is purposely adjusted to have the image-capturing unit 422 facing frontward, upward and rearward, with respect to the case 41.

Therefore, this invention promulgates to provide the revolving lens to the mobile communication device as described above for benefiting the user to make photographs at arbitrary angles. Merits obtained by the present invention can be obvious as follows.

1. When the user needs to take a picture by the mobile communication device, the rotation of the case can be reduced to a minimum. With the rotation range of the revolving lens, the display screen of the phone can always face the user and thus a better image angle can be easily determined.

2. By turning the revolving lens to aim at the object (not the case of the phone), the operation of the shutter located on the case can be easier.

3. By adjusting the revolving lens at various angles to take pictures in sequence without moving the case of the phone, a maximum 180-degree view upon the object can be easily realized.

4. In this embodiment, the revolving lens rotates along the horizontal direction to the x-z plane. It solves the defect to inconvenient for photographing the side scenery in the conventional technology.

It is understood that this invention is not limited to the disclosed embodiments but is intended to cover various arrangements included within the spirit and scope of the broadest interpretation so as to encompass all such modifications and equivalent arrangements.

I claim:

1. A revolving lens set in a case of a mobile communication device, the case having an hole, comprising:
a rotating shaft, mounted pivotally in the hole and revolves along a vertical plane essentially parallel with the case, and the revolving lens rotates with the rotation shaft along a horizontal plane essentially perpendicular to the vertical plane; and
an image-capturing unit, located inside the revolving lens.

2. The revolving lens according to claim 1, wherein said case comprises a display screen, which setting is parallel to the vertical plane.

3. The revolving lens according to claim 2, wherein said revolving lens be opposite to the case by parallel revolving from 0 to 180 degree.

4. The revolving lens according to claim 1, wherein said mobile communication device is a bar-type cell phone.

5. The revolving lens according to claim 1, wherein said mobile communication device is a bar-type PDA.

6. The revolving lens according to claim 1, further comprising a C clip mounted between said rotating shaft and said hole.

7. The revolving lens according to claim 1, further comprising a wedge hook mounted between said rotating shaft and said hole.

8. The revolving lens according to claim 1, wherein said image-capturing unit is a CCD.

9. The revolving lens according to claim 1, wherein said image-capturing unit is a CMOS.

10. A mobile communication device, comprising:
a case, having a hole and a display screen; and
a revolving lens, having a rotating shaft and an image-capturing unit connecting to the case through the hole, wherein the rotating axis is pivotally mounted in the hole and revolves along a vertical plane essentially parallel with the case, and the revolving lens rotates with the rotation shaft along a horizontal plane essentially perpendicular to the vertical plane.

11. The revolving lens according to claim 10, wherein said mobile communication device is a bar-type cell phone.

12. The revolving lens according to claim 10, wherein said mobile communication device is a bar-type PDA.

13. The revolving lens according to claim 10, further comprising a wedge hook mounted between said rotating shaft and said hole.

14. The mobile communication device according to claim 10, further comprising a C clip is mounted between said rotating axis and said hole.

15. The mobile communication device according to claim 10, wherein said image-capturing unit is a CCD.

16. The mobile communication device according to claim 10, wherein said image-capturing unit is a CMOS.

17. The revolving lens according to claim 10, wherein said revolving lens be opposite to the case by parallel revolving from 0 to 180 degree.
